(19) United States
(12) Patent Application Publication
(10) Pub. No.: US 2009/0095788 A1
(43) Pub. Date: Apr. 16, 2009

(54) Engagement-Member Attaching Device

(76) Inventors: Kazuya Shimada, Nagoya-shi (JP); Fujio Saka, Nagoya-shi (JP)

Correspondence Address: OLIFF & BERRIDGE, PLC, P.O. BOX 320850, ALEXANDRIA, VA, 22320-4850, US

(21) Appl. No.: 11/920,983

(22) PCT Filed: May 25, 2006
(86) PCT No.: PCT/JP2006/310428

§ 371 Date: Nov. 23, 2007

(30) Foreign Application Priority Data
May 26, 2005 (JP) 2005-003704

(51) Int. Cl. B25C 5/00

(52) U.S. Cl. 227/136

(57) ABSTRACT

An engagement-member attaching device that is configured, when a connection member is discharged from a rear portion of a body of the device after an engagement member is removed from an engagement-member train, to reduce a burden imposed on an operator and reliably feed the engagement-member train. In a feed mechanism 70, a feeding member 72 is backwardly pivoted based on an operation force of an operation lever 12 against a biasing force of a feeding spring 74 from its feeding position to its preparation position, and then, with the operation force being released, the feeding member 72 is forwardly pivoted by the biasing force of the feeding spring 74 from its preparation position to its feeding position. A booster 100 is provided between a piston member 22 and the feeding member 72, so that a forward force applied to the piston member 22 is boosted and then transmitted to the feeding member 72. As a result, the same force can be applied to the feeding member 72 with less operation force of the operation lever 12. Consequently, even where the biasing force of the feeding spring 74 is made larger, it is possible to reliably feed the engagement-member train received in a reception groove 30 while reducing the burden imposed on the operator.

### TECHNICAL FIELD

The present invention relates to an engagement-member attaching device for inserting an engagement member into a workpiece.

### BACKGROUND ART

An example of the engagement-member attaching device is described in Patent Document 1. This engagement-member attaching device includes (i) a grooved needle disposed in a body of the attaching device, (ii) a reception portion disposed in the body, for receiving a train of a plurality of engagement members that are connected to each other via a connection member, (iii) a feeding mechanism for feeding the train received in the reception portion such that one of the engagement members is positioned in a loading position that corresponds to the grooved needle, (iv) an operation member disposed movably relative to the body, so as to be moved from a home position to an operating position upon application of an operation force to the operation member, and so as to be returned from the operating position to the home portion upon release of the operation force from the operation member, and (v) a piston member connected to the operating member via a transmission mechanism, for pushing one of the engagement members that is positioned in the loading position by the feeding mechanism, into the grooved needle as a result of relative movement of the operation member from the home position to the operating position. Since the grooved needle is being inserted in a workpiece, the engagement member is inserted into the workpiece by the piston member.

In this engagement-member attaching device, after the engagement member is removed from the engagement-member train, the connection member is discharged toward one of opposite sides of the reception portion of the body that is remote from the grooved needle. This arrangement makes it possible to avoid the workpiece from being scratched or damaged by the discharged connection member and to avoid an operation from being interfered by the discharged connection member. [Patent Document 1] JP2001-253419A

### DISCLOSURE OF INVENTION

### Object to be Solved by the Invention

As described above, in the engagement-member attaching device described in Patent Document 1, the connection member is discharged toward the one of the opposite sides (hereinafter referred to as “rear side”) of the reception portion of the body that is remote from the grooved needle. In this arrangement, since the connection member is curved to be guided rearwardly, a large force is required to feed the engagement-member train.

The feeding mechanism is operated based on a force that is applied to the operation member by an operator. Therefore, the operation force applied to the operation member by the operator has to be increased for enabling the engagement-member train to be fed by a large force.

Under the above-described circumstance, an object of the invention is to reduce the operation force that is to be applied to the operation member by the operator in an operation for attaching the engagement member.

### Measure for Achieving the Object and Effects

The above-described object is achieved by, in the engagement-member attaching device including the above-described (i) grooved needle, (ii) reception portion, (iii) feeding mechanism, (iv) operation member and (v) piston member, the feeding mechanism is provided by a pivot-type feeding mechanism including (a) a pivot member which has an engaging claw that is to be engaged with the connection member of the train of the engagement members, and which is held by the body pivotably between a preparation position and a feeding position, and (b) a feeding biasing member which biases the pivot member toward the feeding position. The feeding mechanism is configured, upon application of a drive force to the pivot member as a result of forward movement of the piston member, to cause the pivot member to be pivoted from the feeding position to the preparation position against a biasing force of the feeding biasing member, and being configured, upon release of the drive force from the pivot member, to cause the pivot member to be pivoted from the preparation position to the feeding position by the biasing force of the feeding biasing member while causing the engaging claw to be engaged with the connection member of the train of the engagement members, so as to position a next one of the engagement members in the loading position. The attaching device further includes a booster that is provided between the piston member and the pivot member, for boosting a force of the piston member acting in a forward direction and applying the boosted force to the pivot member.

The piston member is forwardly moved as the operation member is moved by the operator relative to the body from the home position to the operating position. To the piston member, there is applied a force which acts in a forward direction and which is based on an operation force of the operator applied to the operation member. Owing to the drive force based on the forward force, the pivot member is pivoted to the preparation position against the biasing force of the feeding biasing member. Further, upon release of the drive force, the pivot member is pivoted to the feeding position by the biasing force of the feeding biasing member, whereby the engagement-member train received in the reception portion is fed such that one of the engagement members is positioned in the loading position. The engagement member thus positioned in the loading position is pushed by the piston member into the grooved needle, and is then inserted into the workpiece.

The feeding mechanism is of pivot type. The engaging claw of the pivot member is brought into engagement with the connecting member, between a backward pivot motion (hereinafter referred to as “retracting motion” as needed) that is pivot motion of the pivot member in a direction from the feeding position to the preparation position and a forward pivot motion (hereinafter referred to as “feeding motion” as needed) that is pivot motion of the pivot member in the opposite direction, whereby the engagement-member train is fed by a distance that corresponds to one pitch. It is possible to increase the force for feeding the engagement member to the loading position, by increasing the biasing force of the feeding biasing member. However, the increase in the biasing force of the feeding biasing member leads to an increase in a force required to cause the pivot member to be pivoted against the biasing force of the feeding biasing member, thereby requiring the operator to operate the operation member with a large operation force.

On the other hand, in the present engagement-member attaching device in which the booster is provided between the pivot member and the piston member, the forward force of the piston member based on the operation force of the operation member is boosted, and then the boosted forward force is transmitted to the pivot member. This arrangement makes it possible to reduce the operation force of the operation member for generating the same drive force applied to the pivot member. In other words, the engagement-member train can be fed by a large force, even with the operating member being operated by the operator without a large operation force.

Further, since the feeding mechanism is provided by the pivot-type feeding mechanism, it is possible to obtain an effect of increasing a degree of freedom in designing construction and arrangement of the booster and an effect of facilitating provision of a space available for formation of a discharge path that guides the connection member after removal of the engagement member, as described later. A timing at which the engagement-member train is to be fed can be changed by changing the arrangement of the booster.

It is noted that the pivot member is pivoted from the feeding position to the preparation position, by a moment that is applied to the pivot member. An amount of the moment is represented by a product of the drive force applied to the pivot member and a length of an arm. Therefore, the amount of the moment can be increased by increasing the length of the arm, so that the drive force can be reduced for obtaining the same amount of the moment.

Further, the movement of the piston member toward the grooved needle is referred to as forward movement of the piston member, while the movement of the piston member away from the grooved needle is referred to as backward movement of the piston member.

Still further, the operation member may be attached to the body either such that the operation member is linearly movable relative to the body or such that the operation member is pivotable about an axis relative to the body.

### CLAIMABLE FEATURES OF THE INVENTION

There will be described various modes of the invention deemed to contain claimable features for which protection is sought. (Hereinafter they are referred to as “claimable features of the invention”. The claimable features of the invention includes at least “presently claimed invention” or “claimed invention of the present application”, i.e., each of the features recited in claims, and may include more specific concepts of the claimed invention of the present application and even generic concept or another concept of the claimed invention of the present application.) Each of these various modes of the invention is numbered like the appended claims and depends from the other mode or modes, where appropriate, for easier understanding of the claimable features of the invention. It is to be understood that combination of elements constituting the claimable features of the invention is not limited to elements which will be described in the modes. That is, the claimable features of the invention should be interpreted in the light of the following descriptions of the various modes and preferred embodiments of the invention. In a limit in accordance with such an interpretation, a mode of the claimable features of the invention can be constituted by not only any one of these modes but also either a mode provided by, any one of these modes and additional element or elements incorporated therein and a mode provided by any one of these modes without some of elements recited therein.

(1) An engagement-member attaching device comprising:

a grooved needle disposed in a body of the attaching device;

a reception portion disposed in the body, for receiving a train of a plurality of engagement members that are connected to each other via a connection member;

a feeding mechanism for feeding the train received in the reception portion such that one of the engagement members is positioned in a loading position that corresponds to the grooved needle;

an operation member disposed movably relative to the body, so as to be moved from a home position to an operating position upon application of an operation force to the operation member, and so as to be returned from the operating position to the home portion upon release of the operation force from the operation member;

a piston member connected to the operating member via a transmission mechanism, for pushing one of the engagement members that is positioned in the loading position by the feeding mechanism, into the grooved needle as a result of relative movement of the operation member from the home position to the operating position,

wherein the feeding mechanism is a pivot-type feeding mechanism including (a) a pivot member which has an engaging claw that is to be engaged with the connection member of the train of the engagement members, and which is held by the body pivotably between a preparation position and a feeding position, and (b) a feeding biasing member which biases the pivot member toward the feeding position, the feeding mechanism being configured, upon application of a drive force to the pivot member as a result of forward movement of the piston member, to cause the pivot member to be pivoted from the feeding position to the preparation position against a biasing force of the feeding biasing member, and being configured, upon release of the drive force from the pivot member, to cause the pivot member to be pivoted from the preparation position to the feeding position by the biasing force of the feeding biasing member while causing the engaging claw to be engaged with the connection member of the train of the engagement-members, so as to position a next one of the engagement members in the loading position,

and wherein a booster is disposed between the piston member and the pivot member, for boosting a force of the piston member that acts in a forward direction and applying the boosted force to the pivot member.

(2) The engagement-member attaching device according to mode (1), wherein the feeding mechanism includes a return prevention member for preventing movement of the train of the engagement members in a direction that is opposite to a feed direction of the train of the engagement members.

The return prevention member is provided to prevent the engagement-member train from being moved in a direction opposite to the feed direction of the engagement-member train.

It is preferable that the return prevention member has a return prevention claw that is be engaged with the connection member. The return prevention claw is provided to be relatively movable between its return preventing position and its separated position. The return prevention claw is engaged with the connection member so as to prevent movement of the engagement-member train in the opposite direction, when being positioned in the return preventing position. The return prevention claw is separated from the connection member, when being positioned in the separated position. The return prevention claw of the return prevention member is moved, as a result of feed movement of the engagement-member train, between the return preventing position and the separated position.

The return prevention claw may be provided either movably relative to a body of the return prevention member or integrally with the body of the return prevention member. Where return prevention claw is provided movably relative to the body of the return prevention member, a biasing member is provided between the return prevention claw and the body of the return prevention member. Where the return prevention claw is provided integrally with the body of the return prevention member, the biasing member is provided between the return prevention claw and the body of the engagement-member attaching device.

(3) The engagement-member attaching device according to mode (1) or (2), wherein the booster includes an inclined-surface defining member for boosting the force owing to effect of an inclined surface.

The inclined-surface defining member is provided, for example, in each of at least one of the piston member and the pivot member. The inclined-surface defining member has a configuration (inclination direction and inclination amount) that enables, upon forward movement of the piston member, the pivot member to be pivoted toward the preparation position by a predetermined amount of angle (amount of angle between the feeding position and the preparation position about a center of pivot motion)

Owing to the effect of the inclined surface, the force applied to the piston member is boosted and the boosted force is transmitted to the pivot member.

A force Fo applied to the pivot member (force acting in a direction perpendicular to an arm of moment) is represented by an expression as follows, where a forward force applied to the piston member is indicated by Fi while the angle of the inclined surface of the inclined-surface defining member with respect to a direction of movement of the piston member is indicated by θ:

Fo=Fi/tan θ.

Where the angle ε is smaller than 45° (π/4 radians), the forward force Fi of the piston member is boosted and is transmitted to the pivot member so that the force Fo applied to the pivot member is larger than the forward force Fi of the piston member.

(4) The engagement-member attaching device according to mode (3), wherein the inclined-surface defining member is provided in the piston member, while the pivot member includes an arm portion having a contact portion that is to be brought into contact with the inclined-surface defining member.

It is preferable that the contact portion is provide in a distal end portion of the arm portion, so that a length of the arm of moment (distance between the pivot center and a point of application of the force as measured in a direction perpendicular to the direction of the force) can be increased. The arm is disposed with its posture extending backwardly. Where the length of the arm is increased, it is possible to reduce the force that is to be applied to the pivot member for applying the same amount of moment to the pivot member. In other words, the angle θ may be not smaller than 45°. That is, even if the angle θ is not smaller than 45°, it is possible to reduce the operation force that is to be applied to the operation member by the operator for generating the same amount of moment, by increasing the length of the arm so as to increase the moment applied to the pivot member.

(5) The engagement-member attaching device according to any one of modes (1)-(4), wherein the booster includes a plurality of gears that are different from each other with respect of diameter of pitch circle.

The booster may include, for example, a piston-side rack engaged with the piston member, a feeding-side rack engaged with the pivot member, a large-diameter pinion meshing with the piston-side rack, a small-diameter pinion meshing with the feeding-side rack, and a shaft portion holding the large-diameter and small-diameter pinions such that the pinions are coaxial with each other and are rotatable relative to the body of the device. The force applied to the large-diameter pinion is transmitted to the small diameter pinion such that the force Fo applied to the small-diameter pinion and acting in a rotational direction of the small-diameter pinion is made larger than the force Fi applied to the large-diameter pinion and acting in a rotational direction of the large-diameter pinion.

The force Fo applied to the feeding-side rack (force applied to the small-diameter pinion in the rotational direction) is represented with respect to its magnitude by an expression as follows, where diameters of pitch circles of the respective large-diameter and small diameter pinions are indicated by Db, Ds, respectively;

Fo=Fi·Db/Ds.

Since a ratio of the pitch diameter Db of the larger-diameter pinion to the pitch diameter Ds of the small-diameter pinion is larger than one (Db/Ds>1), the force applied to the piston-side rack is boosted and then transmitted to the feeding-side rack.

(6) The engagement-member attaching device according to any one of modes (1)-(5), wherein the booster includes a boost lever pivotable about a fulcrum that is distant from an input portion at which the boost lever is engaged with the piston member and from an output portion at which the boost lever is engaged with the pivot member.

Upon application of the force to the input portion, the boost lever is pivoted about the fulcrum, and the force is applied from the output portion to the pivot member. The force Fo applied from the output portion to the pivot member is represented with respect to its magnitude by an expression as follows, where the force applied to the input portion from the piston member is indicated by Fi, a length between the fulcrum and the input portion is indicated by Li, a length between the fulcrum and the output portion is indicated by Lo, and a lever ratio of the length Li to the length Lo is indicated by y (Li/Lo);

Fo=Fi·y.

Therefore, where the lever ratio y is larger than one, the force applied to the input portion from the piston member is boosted and then applied to the pivot member.

(7) The engagement-member attaching device according to any one of modes (1)-(6), wherein an operation-member biasing member for biasing the operation member toward the home position is disposed between the body and at least one member of a system from the operation member to the piston member via the transmission mechanism.

The operation member is relatively moved by the operation force against a biasing force of the operation-member biasing member from the home position to the operating position, and is returned by the biasing force of the operation-member biasing member from the operating position to the home position upon release of the operation force from the operation member.

The operation-member biasing member is provided between the body and the at least one of members (hereinafter referred to as input members where appropriate) from the operation member to the piston member; For example, the operation-member biasing member may be provided between the body and operation member, between the body and at least one member (hereinafter referred to as at least one transmission member) constituting the transmission mechanism, or between the body and the piston member. In any one of these arrangements, upon release of the operation force, the input members are returned, by the operation-member biasing member, to respective home positions (that causes the operation member to be positioned in its home position).

(8) The engagement-member attaching device according to any one of modes (1)-(7), comprising a discharge path for guiding the connection member, after removal of the engagement members from the train, toward a side of the reception portion of the body that is remote from the grooved needle.

The connection member is, after removal of the engagement members from the engagement-member train, guided along the discharge path so as to be discharged to a rear side of the body. This arrangement makes it possible to avoid the discharged connection member from interfering an operation for operating the operating member.

Therefore, the provision of the booster is effective, particularly, in this arrangement in which a large force is required for feeding the engagement-member train so as to cause the connection member is discharged to the rear side of the body.

(9) The engagement-member attaching device according to any one of modes (1)-(7), comprising a selective discharge device for selectively guiding the connection member, after removal of the engagement members from the train, toward a rear end portion as a side of the reception portion of the body that is remote from the grooved needle and an intermediate portion that is closer to the grooved needle than the rear end portion.

(10) The engagement-member attaching device according to any one of modes (1)-(9), wherein the feeding mechanism includes a mechanism for causing a backward pivot motion of the pivot member from the feeding position to the preparation position and a forward pivot motion of the pivot member from the preparation position to the feeding position in respective states that are the same to each other with respect to position of the piston member relative to the body.

The piston member is moved in response to operation of the operation member, between its backward end position and forward end position. The forward end position is a position of the piston member in which the engagement member is pushed into the grooved needle so as to be inserted into a workpiece. The backward end position is a position of the piston member that corresponds to the home position of the operation member. The backward pivot motion (retracting motion) of the pivot member from the feeding position to the preparation position and the forward pivot motion (feeding motion) of the pivot member from the preparation position to the feeding position may be caused either when the piston member is positioned on a front side of ½ of distance between the backward end position and forward end position or when the piston member is positioned on a rear side of ½ of distance between the backward end position and forward end position.

Further, the backward pivot motion and forward pivot motion of the pivot member may be caused when the piston member is positioned on either a front side or a rear side of a position in which the engagement member is separated from the engagement-member train as a result of forward movement of the piston member.

(11) The engagement-member attaching device according to any one of modes (1)-(9), wherein the feeding mechanism includes a mechanism for causing a backward pivot motion of the pivot member from the feeding position to the preparation position and a forward pivot motion of the pivot member from the preparation position to the feeding position in respective states that are different from each other with respect to position of the piston member relative to the body.

It is preferable that the retracting motion of the pivot member is caused when the piston member is positioned on the front side of ½ of distance between the backward end position and forward end position. Particularly, where the retracting motion is initiated after the piston member pushes at least a part of the engagement member into the grooved needle (after the engagement member is separated from the engagement-member train), it is possible to prevent the engagement member from being deviated from the loading position due to the retracting motion of the pivot member.

It is preferable that the feeding motion of the pivot member is caused when the piston member is positioned on the rear side of ½ of distance between the backward end position and forward end position. Particularly, where the feeding motion is initiated after the piston member is backwardly moved to be positioned on a rear side of the loading position, it is possible to avoid a feed force from being applied to the engagement-member train while feed movement of the engagement-member train is being impeded by the piston member.

(12) The engagement-member attaching device according to any one of modes (1)-(11), wherein the feeding biasing member is a coil spring that is disposed between the pivot member and the body.

The operation-member biasing member may be provided by a coil spring, too.

(13) The engagement-member attaching device according to any one of modes (1)-(12), wherein the piston member includes a body portion that is engaged with the transmission mechanism and a push rod for pushing the engagement members into the grooved needle, and the booster is disposed between the body portion and the pivot member.

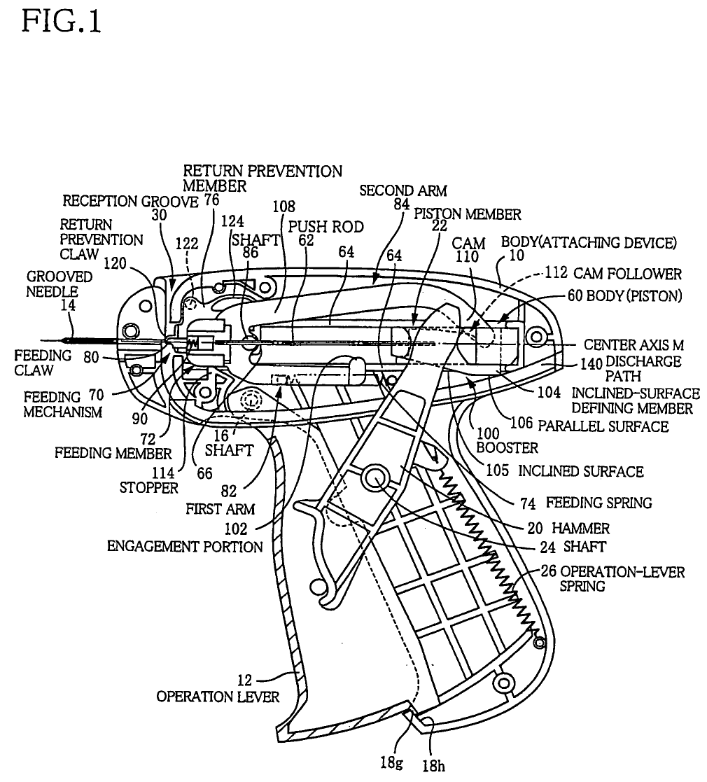

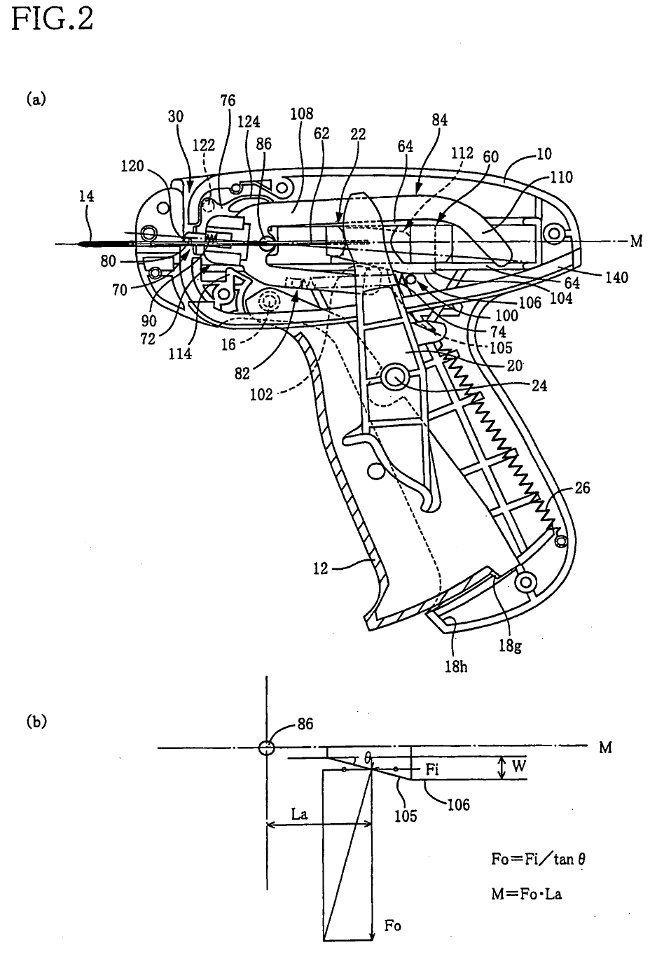

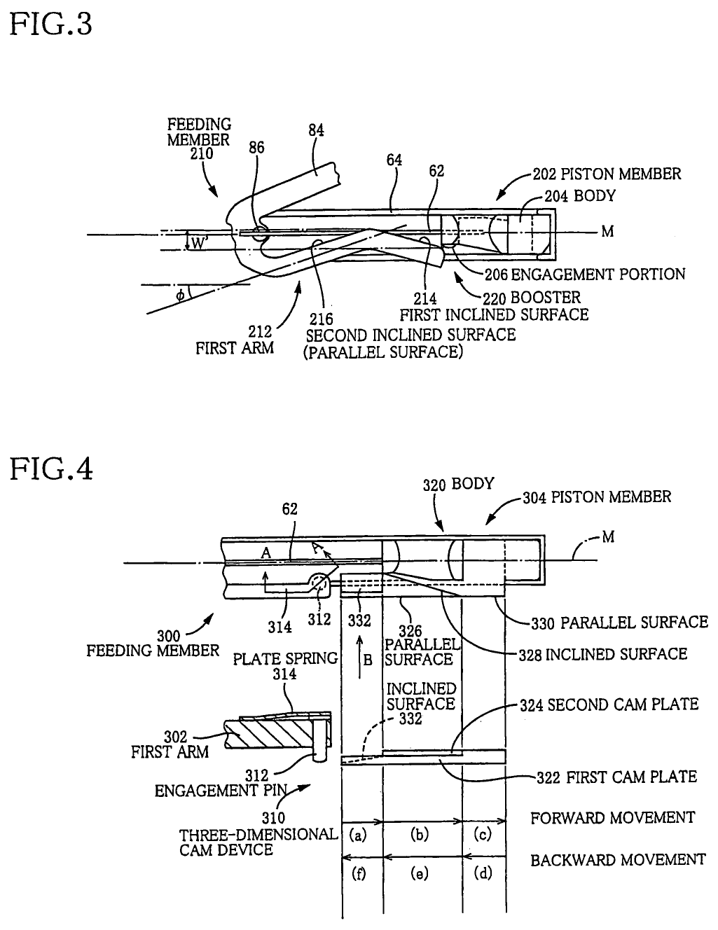

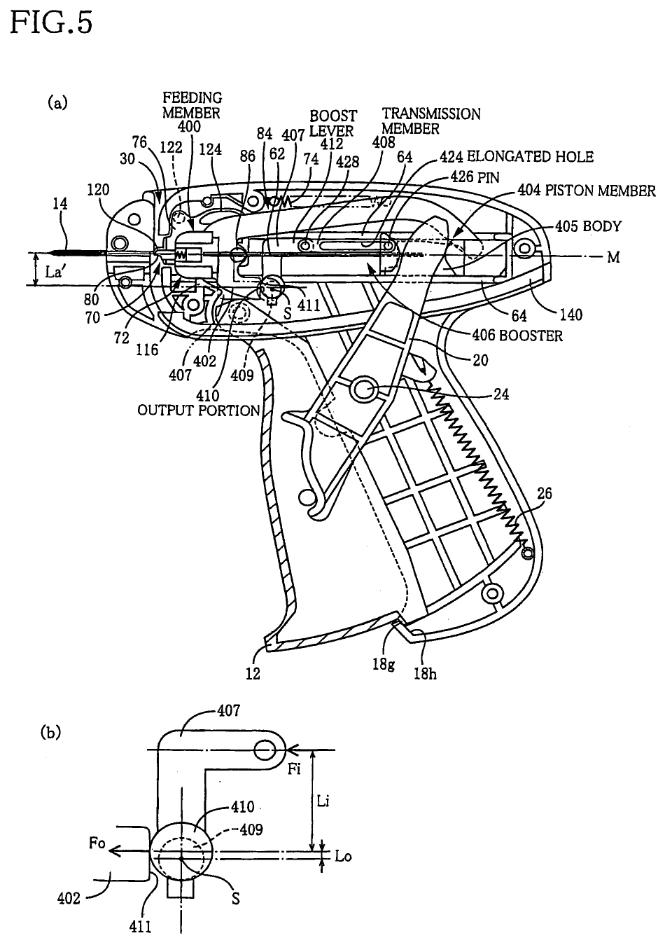

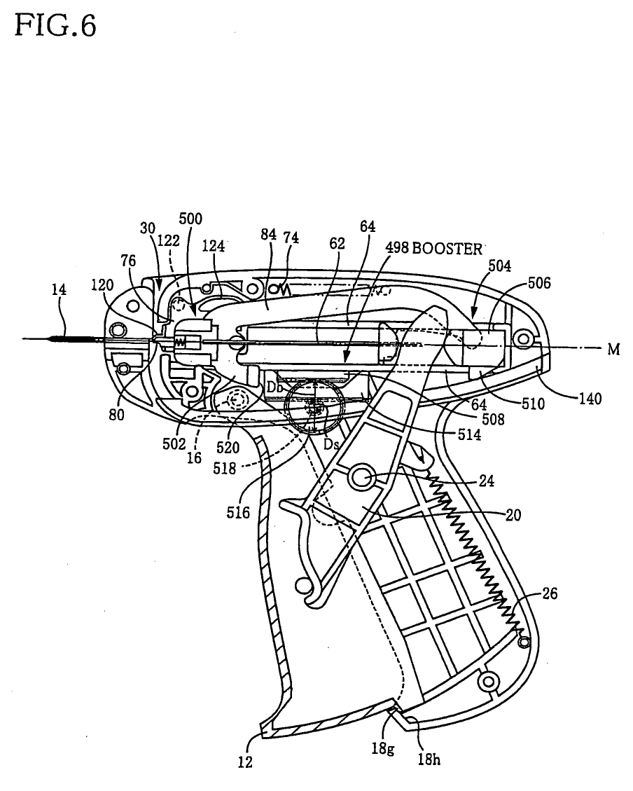

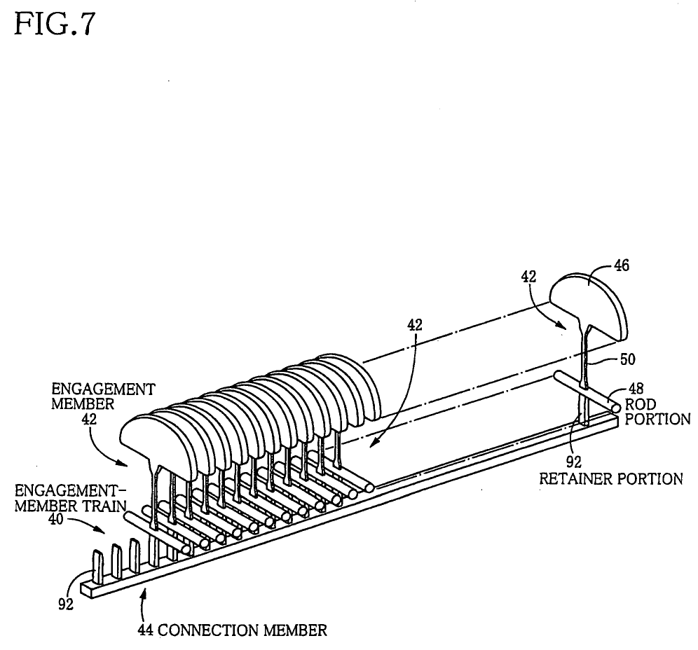

### BRIEF DESCRIPTION OF DRAWINGS

[FIG. 1] A cross sectional view of an engagement-member attaching device that is an embodiment of the present invention.

[FIG. 2] A cross sectional view showing a state of the engagement-member attaching device, which is different from a state in FIG. 1.

[FIG. 3] A view showing a main portion of an engagement-member attaching device that is another embodiment of the present invention.

[FIG. 4] Views showing a main portion of an engagement-member attaching device that is another embodiment of the present invention.

[FIG. 5] A cross sectional view of an engagement-member attaching device that is still another embodiment of the present invention.

[FIG. 6] A cross sectional view of an engagement-member attaching device that is another embodiment of the present invention.

[FIG. 7] A perspective view showing an engagement-member train that is used in each of the above-described engagement-member attaching devices.

### EMBODIMENTS

There will be described an engagement-member attaching device that is an embodiment of the present invention, in detail with reference to the drawings.

In the engagement-member attaching device shown in FIGS. 1 and 2, reference numeral 10 denotes a body of the device, while reference numeral 12 denotes an operation lever as an operation member. In a front portion of the body 10, there is provided a grooved needle 14. The operation lever 12 is attached to the body 10, pivotably about a shaft 16 relative to the body 10. A home position of the operation lever 12 is a position in which a stopper 18g of the operation lever 12 is in contact with an end surface 18h of the body 10. A piston member 22 is connected to the operation lever 12 via a hammer as a transmission member 20. The hammer 20 is engaged at one of its opposite end portions with the operation lever 12, and is engaged at the other of its opposite end portions with the piston member 22. The hammer 20 is attached at its intermediate portion to the body 10, pivotably about a shaft 24. Between the hammer 20 and the body 10, there is provided an operation-lever spring 26 as an operation-member biasing member.

An axis containing the grooved needle 14 of the body 10 (i.e., a line passing through a center of a cross section of a groove of the grooved needle 14) is referred to as a center axis M.

The body 10 is provided with a reception groove 30 as a reception portion extending in a direction that is perpendicular to the grooved needle 14 (center axis M) in a plan view (as seen in a direction perpendicular to a drawing sheet of each of FIGS. 1 and 2), so that an engagement-member train 40 shown in FIG. 7 can be held in the reception groove 30. The engagement-member train 40 includes engagement members 42 and a connection member 44. Each of the engagement members 42 includes a head portion 46, a rod portion 48 and an extending portion 50 that interconnects the head portion 46 and the rod portion 48. The engagement-member train 40 is held by the body 10 such that the connection member 44 is inside the reception groove 30 while the engagement members 42 are outside the reception groove 30, namely, with its posture causing the rod portion 48 of each engagement member 42 to be held in parallel with the center axis M. The engagement-member train 40 is fed along the reception groove 30 in the direction perpendicular to the center axis M in the plan view, such that the rod portion 48 of one of the engagement members 42, which is positioned in its loading position, is aligned with the center axis M.

The piston member 22 includes a body 60 and a push rod 62 that is attached to the body 60. The body 60 of the piston member 22 has an engaged portion that is engaged with the hammer 20. The push rod 62 is attached to the body 60 with its posture aligned with the center axis M (the groove of the grooved needle 14), so as to be insertable into the groove of the grooved needle 14. The piston member 22 is held at its body 60 by the body 10 of the engagement-member attaching device such that the piston member 22 is movable relative to the body 10, along a pair of guide members 64 provided in the body 10. Thus, the push rod 62 is movable relative to the body 10, along the center axis M. The rod portion 48 of one of the engagement members 42, which is positioned in the loading position, is pushed into the grooved needle 14, by a forward movement of the piston member 22, i.e., the push rod 62. A forward end of the movement of the piston member 22 is defined by a stopper 66 that is disposed between the pair of guide members 64. A forward end position of the piston member 22 corresponds to an operating position of the operation lever 12.

A feeding mechanism 70 is of pivot type, and includes a feeding member 72 as a pivot member, a feeding biasing member 74 and a return prevention member 76.

The feeding member 72 includes a feeding claw 80 as an engaging claw and first and second arms 82, 84 as two arms, and is held by the body 10 pivotably about a shaft 86 between its preparation position and feeding position. The feeding claw 80 is held by a body of the feeding member 72, movably relative to the body of the feeding member 72 between its retracting position and engaging position. The feeding claw 80 is biased toward the engaging position, by a spring 90 that is provided between the feeding claw 80 and the body of the feeding member 72. The first and second arms 82, 84 extend rearwardly from the shaft 86, and are engageable with the piston member 22.

Further, a coil spring as a feeding biasing member 74 is disposed between the feeding member 72 and the body 10 of the engagement-member attaching device, so as to bias the feeding member 72 toward the feeding position as shown in FIG. 1. In the present embodiment, the feeding spring 74 is disposed between the body 10 and the first arm 82 of the feeding member 72.

When the feeding member 72 is given a backward pivot motion from the feed position to the preparation position, the feeding claw 80 is brought into contact with a retainer portion 92 (see FIG. 7) of the connection member 44 that retains the engagement member 42, whereby the feeding claw 80 is moved to the retracting position. Then, the feeding claw 80 is moved to the engaging position by separation of the feeding claw 80 from the retainer portion 92.

A booster 100 is disposed between the first arm 82 of the feeding member 72 and the body 60 of the piston member 22. The booster 100 includes an engaging portion 102 provided by a distal end portion of the first arm 82, and an inclined-surface defining member 104 provided in the body 60 of the piston member 22. An inclined surface 105 defined by the inclined-surface defining member 104 is inclined in a direction that increases a deviation of the inclined surface 105 from the center axis M as the inclined surface 105 extends in a rearward direction. An inclination angle θ (defined between the inclined surface 105 and a line that is parallel to the center axis M) is smaller than 45° (π/4 radians).

When the piston member 22 is moved forwardly with the piston member 22 being engaged with the first arm 82, the first arm 82 is given the backward pivot motion so to be pivoted about the shaft 86 in a clockwise direction as seen in FIG. 1 (i.e., in a direction toward the preparation position as shown in FIG. 2 (a)).

As shown in FIG. 2 (b), a force Fo applied to the first arm 82 is represented by an expression as follows, where a forward force applied to the piston member 22 is indicated by Fi while the angle of the inclined surface 105 with respect to a line parallel to the center axis M is indicated by θ:

Fo=Fi/tan θ.

Since the above-described angle θ is smaller than 45′ (π/4 radians), the forward force Fi applied to the piston member is boosted and is transmitted to the first arm 82.

An amount of a moment, which is applied to the feeding member 72, is represented by a product of the force Fo and a length La of an arm, as follows:

M=Fo·La

Therefore, the amount of the moment applied to the feeding member 72 can be increased by increasing the length La of the arm.

Further, the inclined-surface defining member 104 defines also a parallel surface 106 (i.e., surface parallel to the center axis M). The feeding member 72 is given the backward pivot motion by the forward movement of the piston member 22 while the engagement portion 102 of the first arm 82 is engaged with the inclined surface 105. However, while the engagement portion 102 of the first arm 82 is engaged with the parallel surface 106, the feeding member 72 is no longer pivoted even by the forward movement of the piston member 22. That is, while the engagement portion 102 is engaged with the parallel surface 106, the feeding member 72 is held in the preparation position. An inclination amount W (see FIG. 2 (b)) of the inclined surface 105 is determined depending upon, for example, a pivot angle of the feeding member 72 between the feeding and preparation positions and a length of the first arm 82.

As shown in FIGS. 1 and 2, the second arm 84 is curved to be convex outwardly with respect to the center am M, such that the movement of the piston member 22 is not interfered by the second arm 84 even when the feeding member 72 is pivoted backwardly to the preparation position. In a rear portion of the body 60 of the piston member 22, there is provided a cam follower 112 that is engageable with a distal end portion (cam) 110 of the second arm 84. The feeding member 72 is positioned in the feeding position by engagement of the cam 110 of the second arm 84 with the cam follower 112 when the piston member 22 is positioned in its backward end position. If the feeding member 72 could be reliably pivoted to the feeding position in the forward direction only by the feed spring 74, the second arm 84 would not be necessary. However, for example, where the feeding member 72 is not pivoted forwardly to the feeding position by some reason, the feeding member 72 is returned to the feeding position by the cam follower 112 by the engagement of the second arm 84 with the piston member 22 that is positioned in the backward end position.

It is noted that reference numeral 114 denotes a stopper that is provided in the body 10, for limiting the pivot motion of the feeding member 72.

The return prevention member 76 has a return prevention claw 120 that is held by the body 10 such that the return prevention claw 120 is pivotable relative to the body 10 about a shaft 122 between its engaging position and retracting position. Further, although not being shown in the drawings, a support portion that is parallel to the center axis M is provided on one of opposite sides of the body 10 that is remote from the return prevention claw 120, so that the rod portion 48 of the engagement member 42 is supported, at the side of the body 10 that is remote from the return prevention claw 120, by the support portion. The rod portion 48 is held in the loading position by the support portion and the return prevention claw 120. In this sense, a holding device is constituted by at least the support portion and the return prevention member 76.

A return-prevention biasing member 124, which is provided integrally with the return prevention member 76, is elastically deformably held by the body 10. The return prevention claw 120 is biased by the return-prevention biasing member 124, so as to be positioned in the engaging position.

When the engagement-member train 40 is fed by the forward pivot motion of the feeding member 72, the return prevention claw 120 is brought into contact with the retainer portion 92 of the connection member 44, and is pivoted to the retracting position by elastic deformation of the return-prevention biasing member 124. Then, the return prevention claw 120 is pivoted to the engaging position, by biasing force of the holding biasing member 124, upon release of the contact of the return prevention claw 120 with the retainer portion 92.

The body 10 of the engagement-member attaching device is provided with an engagement releasing device that is not shown in the drawings. Owing to the engagement releasing device, the return prevention claw 120 of the return prevention member 76 and the feeding claw 80 of the feeding member 72 can be moved away from the engagement-member train 40 to their respective retracting positions. With the return prevention claw 120 and the feeding claw 80 being positioned in their respective retracting positions, the engagement-member train 40 can be easily removed from the body 10.

Further, the body 10 is provided with a discharge path 140 that is disposed on one of opposite sides of the center axis M that is remote from the reception groove 30. The discharge path 10 is provided with its posture that causes the discharge path 10 to be in communication with the reception groove 30 and to extend toward a rear portion of the body 10. The connection member 44, after removal of the engagement member 42 form the engagement-member train 40, is guided along the discharge path 140 and discharged to a rear side of the body 10.

There will be described an operation of the engagement-member attaching device that is constructed as described above.

The engagement-member train 40 is received in the reception groove 30 of the body 20 such that the rod portion 48 of one of the engagement members 42 is positioned in the loading position that positionally corresponds to the grooved needle 14 aligned with the center axis M.

The hammer 20 is pivoted about the shaft 24, upon application of the operation force to the operation lever 12 by the operator, whereby the piston member 22 is forwardly moved. The operation force applied to the operation lever 12 is transmitted to the piston member 22. With the forward movement of the piston member 22, the push rod 62 is brought into contact with the rod portion 48 of the engagement member 42. The push rod 62 removes the rod portion 48 from the connection member 44, and pushes the removed rod portion 48 into the grooved needle 14.

When the piston member 22 is forwardly moved to a position that causes the rod portion 48 of the engagement member 42 to be pushed by the push rod 62 into inside of the grooved needle 14, the inclined surface 105 of the piston member 22 and the engagement portion 102 of the first arm 82 are brought into contact with each other. In this state, as a result of the forward movement of the piston member 22, the feeding member 72 is backwardly pivoted (in the clockwise direction), against the biasing force of the feeding spring 74, from the feeding position as shown in FIG. 1 to the preparation position as shown in FIG. 2. In this instance, owing to effect of the inclined surface 105, the forward force of the piston member 22 is boosted and the boosted forward force is applied as a drive force to the feeding member 72. Since the application of the drive force to the feeding member 72 is made at a point of time that is staggered from a point of time of the separation of the rod portion 48 from the connection member 44, it is possible to reduce the operation force that is to be applied to the operation lever 12. While the parallel surface 106 of the piston member 22 and the engagement portion 102 of the first arm 82 are in contact with each other, the feeding member 72 is held in the preparation position without the pivot movement of the feeding member 72, even with the forward movement of the piston member 22.

Upon release of the operation force from the operation lever 12, the operation lever 12 is returned to the home position by the biasing force of the operation-lever spring 26, whereby the piston member 22 is backwardly moved to the backward end position. During a backward movement of the push rod 62 as a result of the backward movement of the piston member 22, the engagement of the engagement portion 102 of the first arm 82 and the inclined surface 105 of the inclined-surface defining member 104 is initiated when a distal end of the push rod 62 still remains inside the grooved needle 14, whereby the forward pivot motion of the feeding member 72 to the feeding position is allowed. However, as long as the push rod 62 is in the position (loading position) corresponding to the reception groove 30 lying on the center axis M, the feed movement of the engagement-member train 40 (in a direction which is perpendicular to the center axis M in the plan view and which causes the engagement member 42 to approach the center axis M) is inhibited by the push rod 62 so that the feeding member 72 is not forwardly pivoted to the feeding position. In this state, the engagement portion 102 is separated from the inclined surface 105.

When the piston member 22 is backwardly moved to a position that causes the distal end of the push rod 62 to be positioned on a rear side of a position that corresponds to the reception groove 30 lying on the center axis M, the forward pivot motion of the feeding member 72 is allowed whereby the feeding member 72 is forwardly pivoted to the feeding position by the biasing force of the feeding spring 74. An amount of pivot motion of the feeding member 72 is small, and an amount of expansion and contraction of the feeding spring 74 is small, too. Therefore, the biasing force of the feeding spring 74 is determined depending upon its spring set load.

As a result of the forward pivot motion of the feeding member 72 to the feeding position, the feeding claw 80 feeds the engagement-member train 40 until the rod portion 48 of a next one of the engagement members 42 is positioned in the loading position that is aligned with the center axis M.

When the piston member 22 is backwardly moved to the backward end position, the piston member 22 is brought into engagement with the second arm 84. Therefore, even if the feeding member 72 does not reach the feeding position by some reason, the feeding member 72 is reliably pivoted to the feeding position by engagement of the cam 110 of the distal end of the second arm 84 with the cam follower 112. In this instance, the biasing force of the operation-lever spring 26 helps the forward pivot motion of the feeding member 72 to the feeding position, which is caused by the biasing force of the feeding spring 74.

Further, the connection member 44, after removal of the engagement member 42 from the engagement-member train 40, is discharged from a rear end portion of the body 10. In this arrangement, since the connection member 44 is curved to be guided rearwardly, a large force is required to feed the engagement-member train 40. To this end, the biasing force of the feeding spring 74 is adapted to be large. Since the biasing force of the feeding spring 74 is large, a large force is required to cause the feeding member 72 to be backwardly pivoted form the feeding position to the preparation position, thereby requiring the operator to apply a large force to the operation lever 12. However, since the booster 100 is disposed between the piston member 22 and the feeding member 72, the forward force applied to the piston member 22 is boosted and is then transmitted to feeding member 72. Consequently, it is possible to cause the feeding member 72 to be backwardly pivoted from the feeding position to the preparation position, without the operation lever 12 being operated by the operator with the large force. That is, it is possible to cause the engagement-member train 40 to be reliably fed while reducing a burden imposed on the operator. In the engagement-member attaching device, inherently, the piston member 22 requires to have a large stroke, and a part of the stroke of the piston member 22 is utilized for the pivot motion of the feeding member 72. Therefore, the provision of the booster 100 does not require increase of the stroke of the piston member 22, so that the booster 100 can be provided without the engagement-member attaching device being made large in size.

Further, in the present embodiment, the backward pivot motion of the feeding member 72 from the feeding position to the preparation position is initiated in a state in which the push rod 62 is in contact with the rod portion 48 of the engagement member 42 so that at least a part of the rod portion 48 is inserted in the grooved needle 14. This arrangement is effective to prevent the engagement member 42 from being deviated from the loading position and to enable the engagement member 42 to be reliably inserted into the workpiece.

In the above-described embodiment, the backward pivot motion of the feeding member 72 from the feeding position to the preparation position is initiated from a point of time at which the distal end of the push rod 62 enters inside the grooved needle 14, and the forward pivot motion of the feeding member 72 from the preparation position to the feeding position is allowed from a point of time at which the distal end of the push rod 62 is still inside the grooved needle 14. However, the arrangement may be modified such that the backward pivot motion of the feeding member 72 from the feeding position to the preparation position is initiated from a point of time at which the piston member 22 is forwardly moved a little from the backward end position, and the forward pivot motion of the feeding member 72 from the preparation position to the feeding position is allowed after the distal end of the push rod 62 is removed out of the grooved needle 14 so as to be positioned on a rear side of the loading position.

An example of the thus modified arrangement is shown as another embodiment in FIG. 3. In this embodiment, the inclined-surface defining member is provided in the feeding member rather than in the piston member.

As shown in FIG. 3, an engagement portion 206 is provided in a body 204 of a piston member 202. Further, first and second inclined surfaces 214, 216 are formed in a first arm 212 of a feeding member 210. An amount W′ of inclination of the first inclined surface 214 is dependent on an amount of pivot motion of the feeding member 210, while an angle φ of inclination of the second inclined surface 216 is an angle that causes the second inclined surface 216 is in parallel to the center axis M when the feeding member 210 is positioned in the preparation position. In this sense, the second inclined surface 216 may be referred to as a parallel surface. In the present embodiment, the inclined-surface defining member is constituted by at least the first inclined surface 214 of the first arm 212, while the booster 220 is constituted by at least the first inclined surface 214 and the engagement portion 206.

When the piston member 202 is forwardly moved a little from the backward end position, the engagement portion 206 is brought into engagement with the first inclined surface 214 whereby the feeding member 210 is backwardly pivoted in the clockwise direction by the forward movement of the piston member 202. When the feeding member 210 reaches the preparation position, the engagement portion 206 is brought into contact with the second inclined surface 216. In this instance, since the second inclined surface 216 is in parallel to the center axis M, the feeding member 210 is held in the preparation position even by further forward movement of the piston member 202. Thus, in the present embodiment, when the piston member 202 is in vicinity of the backward end position, namely, before the push rod 62 is brought into contact with the rod portion 48 of the engagement member 42, the feeding member 210 is backwardly pivoted from the feeding position to the preparation position.

In the backward movement of the piston member 202, the forward pivot motion of the feeding member 210 from the preparation position to the feeding position is initiated after the push rod 62 is backwardly moved from the loading position, namely, after initiation of the engagement of the engagement portion 206 of the piston member 202 with the first inclined surface 214. In this instance, the engagement portion 206 and the first inclined surface 214 are held in engagement with each other, so that the feeding member 210 is given the forward pivot motion as a result of the backward movement of the piston member 202. Thus, in the present embodiment, the forward pivot motion of the feeding member 210 to the feeding position is initiated after the distal end of the push rod 52 is positioned on a rear side of the loading position. This arrangement makes it possible to avoid a force (acting in a direction perpendicular to the center axis M) from being applied to the push rod 62 due to the feed movement of the engagement-member train 40.

Further, it is possible to modify the arrangement such that the backward pivot motion of the feeding member 72 from the feeding position to the preparation position and the forward pivot motion of the feeding member 72 from the preparation position to the feeding position are made at respective different points of time. An example of the thus modified arrangement is shown as another embodiment in FIG. 4. In this embodiment, the backward pivot motion of the feeding member from the feeding position to the preparation position is initiated after the distal end of the push rod 62 enters inside the grooved needle 14, and the forward pivot motion of the feeding member from the preparation position to the feeding position is initiated after the distal end of the push rod 62 is positioned on the rear side of the loading position.

A three-dimensional cam device 300 serving also as the booster is disposed between a first arm 302 and a piston member 304. As shown in a cross sectional view taken along line A-A, an engagement pin 312 is provided in the first arm 302 such that the engagement pin 312 is movable relative to the first arm 302 in a direction that is perpendicular to the center axis M as seen from arrow B. A plate spring 314 is provided in the first arm 302 so as to bias the engagement pin 312 toward its projecting position. First and second cam plates 322, 324 are provided in a body 320 of the piston member 304. The first cam plate 322 has a parallel surface 326 that is parallel to the center axis M. The second cam plate 324 has an inclined surface 328 and a parallel surface 330. The inclined surface 328 is inclined with respect to the center axis M in the plan view. The parallel surface 330 is located on a rear side of the inclined surface 328. Further, an inclined surface 332 is provided in a front portion of the first cam plate 322, and is inclined with respect to the center axis M as seen from arrow B.

In the present embodiment, the engagement pin 312 as a cam follower is engaged with the cam plate which is changed as the piston member 304 is moved relative to the body 10.

During forward movement of the piston member 304, in a state in which the engagement pin 312 is positioned in region (a), the engagement pin 312 is engaged with the inclined surface 332 of the first cam plate 322, so as to be pressed upwardly against a biasing force of the plate spring 314, thereby reducing an amount of projection of the engagement pin 312 from the first arm 302. In a state in which the engagement pin 312 is positioned in region (b), the engagement pin 312 is engaged with the inclined surface 328 of the second cam plate 324. In this state, the engagement pin 312 is moved in a direction away from the center axis M by the inclined surface 328, whereby the feeding member 72 is backwardly moved from the feeding position to the preparation position. Then, since the engagement pin 312 is separated from the first cam plate 322, the engagement pin 312 is caused by the biasing force of the plate spring 314, to project from the first arm 302, thereby increasing the amount of projection of the engagement pin 312. In a state in which the engagement pin 312 is positioned in region (c), the engagement pin 312 is engaged with the parallel surface 330 so that the feeding member 300 is held in the preparation position.

Thus, in the present embodiment, the backward pivot motion of the feeding member 300 from the feeding position to the preparation position is initiated at a point of time at which the engagement pin 312 is brought into contact with the second cam plate 324. That is, as in the above-described first embodiment, the backward pivot motion is initiated after the distal end of the push rod 62 enters inside the grooved needle 14.

During backward movement of the piston member 304, the engagement pin 312 is moved to be positioned in regions (d), (e), (f) in this order of description, and the engagement pin 312 is engaged with the parallel surfaces 330, 326. The forward pivot motion of the feeding member 300 from the preparation position to the feeding position is inhibited by the engagement of the engagement pin 312 with the parallel surfaces 330, 326. When the engagement pin 312 is separated from the parallel surface 326, the first arm 302 is allowed to be pivoted in the counterclockwise direction, whereby the feeding member 72 is forwardly pivoted to the feeding position by the feeding spring 74.

This forward pivot motion of the feeding member 72 to the feeding position is allowed after the distal end of the push rod 62 is positioned on a rear side of the a portion of the reception groove 30 corresponding to the center axis M, i.e., on a rear side of the loading position. This arrangement makes it possible to avoid a force (acting in a direction perpendicular to the center axis M) from being applied to the push rod 62 due to the feed movement of the engagement-member train 40 that is caused by the forward pivot motion of the feeding member 72 from the preparation position to the feeding position.

Further, the booster may be modified to be equipped with a boost lever. An example of the thus modified arrangement is shown as another embodiment in FIG. 5.

In this embodiment, a feeding member 400 has a first arm 402 whose length is smaller than that in the above-described first embodiment. Further, a body 405 of a piston member 404 is not provided with the inclined-surface defining member 104 that is provided in the above-described first embodiment. A booster 406 is not provided between the first arm 402 of the feeding member 400 and the body 405 of the piston member 404.

The booster 406 includes a boost lever 407 and a transmission member 408. The boost lever 407 is provided in the body 10, pivotably relative to the body 10 about a shaft 409. The boost lever 407 is held in contact at its output portion 410 with a backward surface 411 of the first arm 402. The boost lever 407 receives, at its input portion 412, a forward force that is applied to the piston member 404 via the transmission member 408. The transmission member 408 is a member extending in its longitudinal direction, and has an elongated hole 424 that is elongated in the longitudinal direction. The transmission member 408 is engaged at one of its opposite end portions, i.e., at the elongated hole 424, with a pin 426 that is provided in the piston member 404. The transmission member 408 is attached at the other of its opposite end portions to the boost lever 407, with a pin 428 that is provided in the boost lever 407, such that the transmission member 408 is pivotable relative to the boost lever 407 about the pin 428. The piston member 404 is movable relative to the transmission member 408 by a distance that is determined by the elongated hole 426. While the piston member 404 is moved by this distance, the forward force applied to the piston member 404 is not transmitted to the boost lever 407. Further, owing to the elongated hole 424 and the pin 426, the transmission member 408 is pivotable relative to the piston member 404. It is noted that the feeding spring 74 is disposed between the second arm 84 and the body 10.

When the piston member 104 is forwardly moved from a position as shown in FIG. 5 (a) upon application of an operation force to the operation lever 12, the pin 426 is moved along the elongated hole 424 relative to the transmission member 408.

Upon contact of the pin 426 with a front end surface as a result of the forward movement of the piston member 404, a force applied to the piston member 404 and acting in the forward direction is applied to the input portion 412 of the boost lever 407 via the pin 428. With further forward movement of the piston member 404, the boost lever 407 is pivoted about a fulcrum S in counterclockwise direction as seen in FIGS. 5 (a), (b), whereby a force is applied from the output portion 410 to the backward surface 411 of the first arm 402. The feeding member 72 is backwardly pivoted against the biasing force of the feeding spring 74, from the feeding position to the preparing position.

In this instance, a force Fo applied from the output portion 410 to the first arm 402 is represented with respect to its magnitude, by an expression as follows, where a distance between the fulcrum S and the output portion 410 is indicated by Lo, a distance between the fulcrum S and the input portion 412 is indicated by Li, and the forward force applied to the input portion 412 via the transmission member 408 is indicated by Fi;

Fo=Fi·Li/Lo.

Thus, the force Fi applied to the input portion 412 is boosted, and the boosted force is applied to the first arm 402.

Further, a moment Fi applied to the feeding member 400 is represented with respect to its amount by a product of the output force Fo and an arm length La′, as follows:

M=Fo·La′.

When the operation force applied to the operation lever 12 is released, the piston member 404 is backwardly moved. The boost lever 407 is allowed by the backward movement of the piston member 404, to be pivoted in clockwise direction. However, as in the first embodiment, as long as the push rod 62 is in the position corresponding to the reception groove 30 lying on the center axis M, the engagement-member train 40 cannot be moved in a direction perpendicular to the center axis M. Thus, when the distal end of the push rod 62 is moved backwardly to be positioned on the rear side of the position corresponding to the reception groove 30, the feeding member 400 is forwardly pivoted to the feeding position by the feeding spring 74.

Further, the booster may be modified to include a plurality of racks and pinions, as in another embodiment shown in FIG. 6.

In this embodiment, as in the embodiment shown in FIG. 5, a first arm 502 is short. Further, a body 506 of a piston member 504 is provided with a contact portion 510 that is to be brought into contact with a piston-side rack 508.

The piston-side rack 508 and an arm-side rack 514 are included in a booster 498, and are attached to the body 10, movably relative to the body 10 is a direction parallel to the center axis M. The booster 498 further includes a large-diameter pinion 516 and a small-diameter pinion 518 which are coaxial with each other and which are rotatable relative to the body 10. The arm-side rack 514 is contactable with a backward surface 520 of the first arm 502, and meshes with the small-diameter pinion 518. The piston-side rack 508 is contactable with the contact portion 510 of the piston member 504, and meshes with the large-diameter pinion 516. The larger-diameter pinion 516 and the piston-side rack 508 lie on a plane on which the contact portion 510 of the piston member 504 lies, while the small-diameter pinion 518 and the arm-side rack 514 lie on another plane on which the feeding member 500 lies. The above-described plane and another plane are different from each other, so that the larger-diameter pinion 516, piston-side rack 508 and the contact portion 510 do not interfere with the small-diameter pinion 518, arm-side rack 514 and feeding member 500.

The piston-side rack 508 and the arm-side rack 514 are movable relative to the body 10 along respective guide members (not shown), in a direction parallel to the center axis M.

An output force Fo, which acts in the direction parallel to the center axis M and is applied from the arm-side rack 514 to the backward surface 520 of the first arm 502, is represented by an expression as follows, where a forward force applied from the piston member 504 to the piston-side rack 508 is indicated by Fi while pitch diameters of the larger-diameter pinion 516 and small-diameter pinion 518 are indicated by Db, Ds, respectively;

Fo=Fi·Db/Ds.

Since a ratio of the larger-diameter pinion 516 to the small-diameter pinion 518 with respect to the pitch circle is larger than one (Db/Ds>1), the forward force applied to the piston member 504 is boosted and then transmitted to the first arm 502.

When the piston member 504 is moved forwardly, the contact portion 510 is brought into contact with the piston-side rack 508. The piston-side rack 508 is moved forwardly by the forward movement of the piston member 504, whereby the larger-diameter pinion 516 is rotated and the small-diameter pinion 518 is rotated. As a result of the rotation of the small-diameter pinion 518, the arm-side rack 514 is moved forwardly so as to be brought into contact with the backward surface 520 of the first arm 502. As a drive force is thus applied to the feeding member 500, the feeding member 500 is backwardly pivoted from the feeding position to the preparing position. The forward force applied to the piston member 504 is boosted and is then transmitted to the first arm 502, as is apparent from the above-described expression, so that the feeding member 500 can be pivoted backwardly to the preparation position by a small operation even if the biasing force of the feeding spring 74 is large.

When the piston member 504 is backwardly moved, the contact portion 510 is separated from the piston-side rack 508, whereby the piston-side rack 508 is allowed to be moved backwardly. In this instance, since the backward movement of the piston-side rack 508 is allowed, the large-diameter pinion 516 and the small-diameter pinion 518 are allowed to be rotated in the opposite direction whereby the arm-side rack 514 is allowed to be moved backwardly. As in the above-described embodiments, when the push rod 62 is removed out of the grooved needle 14 so as to be positioned on a rear side of the position corresponding to the reception groove 30, the feeding member 500 is pivoted forwardly by the biasing force of the feeding spring 74 from the preparation position to the feeding position.

It is noted that the piston member 504 may be modified such that the contact portion 510 is provided in a front portion of the body 506 of the piston member 504.

Further, the construction of the engagement-member attaching device is not necessarily limited to details of the above-described embodiments.

For example, the length of the second arm 84 of the feeding member may be reduced, because the feeding member does not necessarily have to be in engagement with the piston member that is positioned in the backward end position. Further, the second arm as such is not essential.

Further, the booster of each of the embodiments can be applied also to an engagement-member attaching device in which the connection member is not discharged from a backward surface of the body.

Moreover, the present invention may be carried out not only with the above-described modes but also with various modifications and improvements that are based on knowledge of those skilled in the art.

1.-13. (canceled)

14. An engagement-member attaching device comprising:
a grooved needle disposed in a body of said attaching device;
a reception portion disposed in said body, for receiving a train of a plurality of engagement members that are connected to each other via a connection member;
a feeding mechanism for feeding said train received in said reception portion such that the engagement members are positioned one after another, in a loading position that is aligned with said grooved needle;
an operation member disposed movably relative to said body, so as to be moved from a home position to an operating position upon application of an operation force to said operation member, and so as to be returned from the operating position to the home portion upon release of the operation force from said operation member;
a piston member connected to said operating member via a transmission mechanism, for pushing one of said engagement members that is currently positioned in the loading position by said feeding mechanism, into said grooved needle as a result of movement of said operation member relative to said body from the home position to the operating position,
wherein said feeding mechanism includes (a) a pivot member which has an engaging claw that is to be engaged with the connection member of the train of the engagement members, and which is held by said body pivotably between a preparation position and a feeding position, and (b) a feeding biasing member which biases said pivot member toward said feeding position,
wherein said feeding mechanism is configured, upon application of a drive force to said pivot member as a result of forward movement of said piston member, to cause said pivot member to be pivoted from the feeding position to the preparation position against a biasing force of said feeding biasing member,
and wherein said feeding mechanism is configured, upon release of the drive force from said pivot member, to cause said pivot member to be pivoted from the preparation position to the feeding position by the biasing force of said feeding biasing member while causing said engaging claw to be engaged with the connection member of the train of the engagement members, so as to position a next one of said engagement members in the loading position,
said attaching device further comprising a booster that is disposed between said piston member and said pivot member, for boosting a force of said piston member that acts in a forward direction and applying the boosted force to said pivot member.

15. The engagement-member attaching device according to claim 14, wherein said feeding mechanism includes a return prevention member for preventing movement of said train of the engagement members in a direction that is opposite to a feed direction of the train of the engagement members.

16. The engagement-member attaching device according to claim 14, wherein said booster includes an inclined-surface defining member for boosting the force owing to effect of an inclined surface that is defined by said inclined-surface defining member.

17. The engagement-member attaching device according to claim 16, wherein said inclined-surface defining member is provided in said piston member, while said pivot member includes an arm portion having a contact portion that is to be brought into contact with said inclined-surface defining member.

18. The engagement-member attaching-device according to claim 14, wherein said booster includes a plurality of gears that are different from each other with respect of diameter of pitch circle.

19. The engagement-member attaching device according to claim 14,
wherein said booster includes a boost lever having (i) an input portion at which said boost lever is engaged with said piston member and (ii) an output portion at which said boost lever is engaged with said pivot member,
and wherein said boost lever is pivotable about a fulcrum that is distant from said input portion and said output portion.

20. The engagement-member attaching device according to claim 14, further comprising an operation-member biasing member for biasing said operation member toward the home position,
wherein said operation-member biasing member is disposed between said body and at least one member of an operation force transmission system that includes said operation member, said piston member and said transmission mechanism.

21. The engagement-member attaching device according to claim 14, further comprising a discharge path for guiding the connection member, after removal of the engagement members from the train, toward one of opposite sides of said reception portion, which is remote from said grooved needle.

22. The engagement-member attaching device according to claim 14, wherein said feeding mechanism includes a mechanism for causing a backward pivot motion of said pivot member from the feeding position to the preparation position and a forward pivot motion of said pivot member from the preparation position to the feeding position, such that said backward pivot motion and said forward pivot motion are caused in respective states that are the same to each other with respect to position of said piston member relative to said body.

23. The engagement-member attaching device according to claim 14, wherein said feeding mechanism includes a mechanism for causing a backward pivot motion of said pivot member from the feeding position to the preparation position and a forward pivot motion of said pivot member from the preparation position to the feeding position, such that said backward pivot motion and said forward pivot motion are caused in respective states that are different from each other with respect to position of said piston member relative to said body.

24. The engagement-member attaching device according to claim 14, wherein said feeding biasing member is a coil spring that is disposed between said pivot member and said body.

25. The engagement-member attaching device according to claim 14,
wherein said piston member includes a body portion that is engaged with said transmission mechanism and a push rod for pushing the engagement members into said grooved needle,
and wherein said booster is disposed between said body portion and said pivot member.
